(19) United States
(12) Patent Application Publication
(10) Pub. No.: US 2010/0230199 A1
(43) Pub. Date: Sep. 16, 2010

(54) MOTORCYCLE HAVING A MULTI-FUNCTIONAL REAR BRAKE CALIPER BRACKET

(75) Inventors: Andrew Roth, West Bend, WI (US); Mark Gales, Wauwatosa, WI (US); Rodney Weekley, Mequon, WI (US); Christopher Poquette, Neenah, WI (US); Joseph M. Dennert, New Berlin, WI (US); Michael Medina, Brookfield, WI (US)

Correspondence Address: MICHAEL BEST & FRIEDRICH LLP, 100 E WISCONSIN AVENUE, Suite 3300, MILWAUKEE, WI, 53202, US

(73) Assignee: HARLEY-DAVIDSON MOTOR COMPANY GROUP, LLC, Milwaukee, WI (US)

(21) Appl. No.: 12/402,157

(22) Filed: Mar. 11, 2009

(51) Int. Cl. B62K 11/00; B60T 1/00

(52) U.S. Cl. 180/219; 188/18 A

(57) ABSTRACT

A motorcycle includes a rear brake caliper bracket coupled to the swingarm. In some constructions, the rear brake caliper bracket includes a caliper mounting portion and a license plate mounting portion. In some constructions, the rear brake caliper bracket includes an axle engaging portion secures and retains the axle relative to the swingarm in a desired position along the axis of rotation. In some constructions, the rear brake caliper bracket is disposed at a laterally outward side of the swingarm and includes a caliper mounting portion, first and second swingarm engaging portions, and an axle engaging portion. In such constructions, the motorcycle may further include an axle adjusting member engaged with the rear brake caliper bracket and operable to adjust the position of the axle relative to the swingarm.

### BACKGROUND

The present invention relates to the mounting of a rear brake caliper on a motorcycle. More particularly, the invention relates to a motorcycle having a rear brake caliper bracket provided with features to enhance the functionality of the rear brake caliper bracket beyond mounting the rear brake caliper.

### SUMMARY

In one embodiment, the invention provides a motorcycle including a frame, a swingarm coupled to the frame, and a rear wheel coupled to the swingarm so that the rear wheel is rotatable relative to the swingarm and movable with the swingarm relative to the frame. A brake disc is coupled to the rear wheel to rotate with the rear wheel. A rear brake caliper bracket is coupled to the swingarm and includes a caliper mounting portion and a license plate mounting portion. A brake caliper is coupled to the caliper mounting portion of the rear brake caliper bracket and configured to selectively squeeze the brake disc to decelerate the rear wheel.

In another embodiment, the motorcycle includes an axle extending through the center of the rear wheel to define an axis of rotation of the rear wheel with respect to the swingarm. The rear brake caliper bracket includes an axle engaging portion engaged with the axle, and a caliper mounting portion. The axle engaging portion secures and retains the axle relative to the swingarm in a desired position along the axis of rotation.

In yet another embodiment, the motorcycle's rear brake caliper bracket is disposed at a laterally outward side of the swingarm. The rear brake caliper bracket includes a caliper mounting portion, first and second swingarm engaging portions, and an axle engaging portion. The motorcycle further includes an axle adjusting member engaged with the rear brake caliper bracket and operable to adjust the position of the axle relative to the swingarm.

Other aspects of the invention will become apparent by consideration of the detailed description and accompanying drawings.

### BRIEF DESCRIPTION OF THE DRAWINGS

FIG. 1 is a side view of a motorcycle.

FIG. 2 is a perspective view of a rear wheel assembly of the motorcycle of FIG. 1.

FIG. 3 is a detail perspective view of a rear brake caliper bracket as shown in FIG. 2.

FIG. 4 is a perspective view of the rear brake caliper bracket of FIG. 3.

FIG. 5 is an alternate perspective view of the rear brake caliper bracket of FIG. 3.

FIG. 6 is a cross-sectional view of the rear wheel assembly, taken along line 6-6 of FIG. 2.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

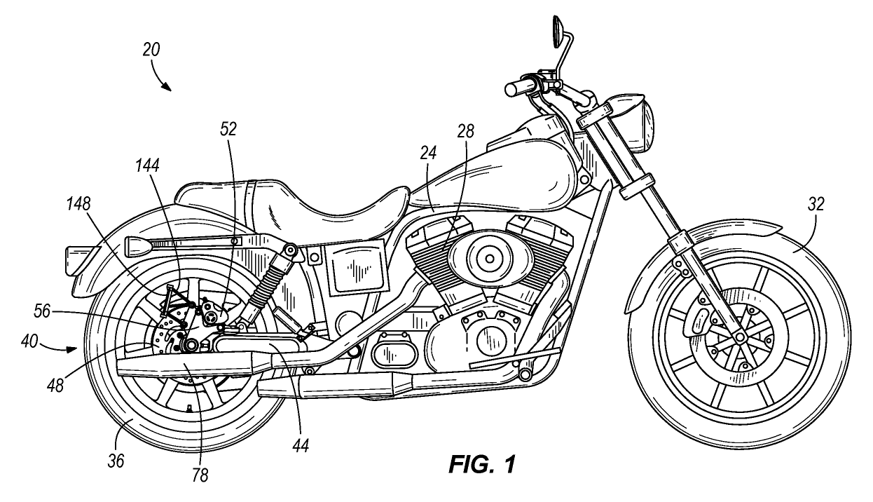

FIG. 1 illustrates a motorcycle 20 including a frame 24, an engine 28, a front wheel 32, and a rear wheel 36. The rear wheel 36 is driven by the engine 28 and is part of a rear wheel assembly 40 movably coupled to the frame 24 by a swingarm 44. A rear brake disc 48 is coupled to the rear wheel 36 to rotate with the rear wheel 36. A brake caliper 52 is supported by a swingarm-mounted rear brake caliper bracket 56 in position to selectively squeeze the brake disc 48 to decelerate the rear wheel 36 and thus, the motorcycle 20.

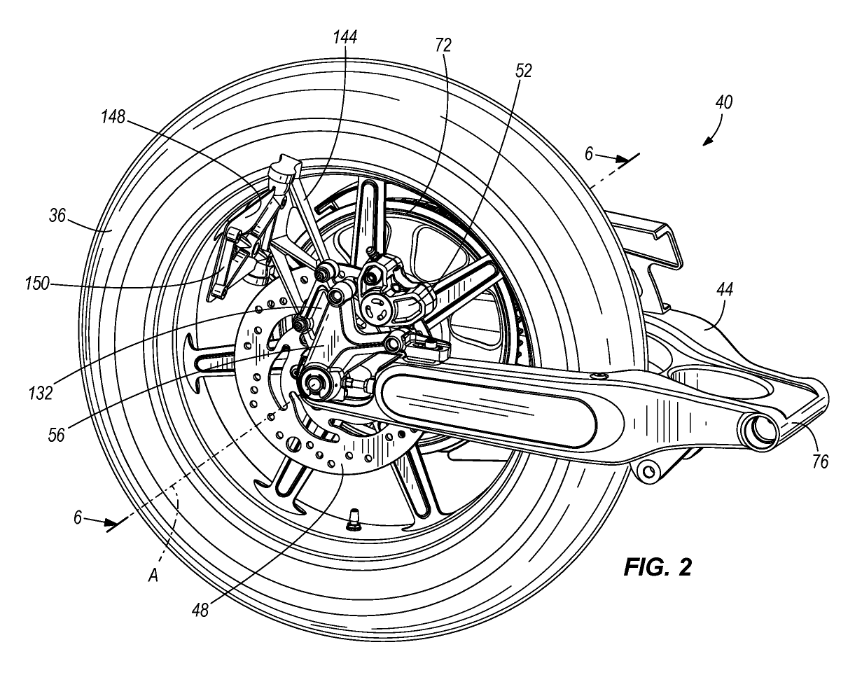

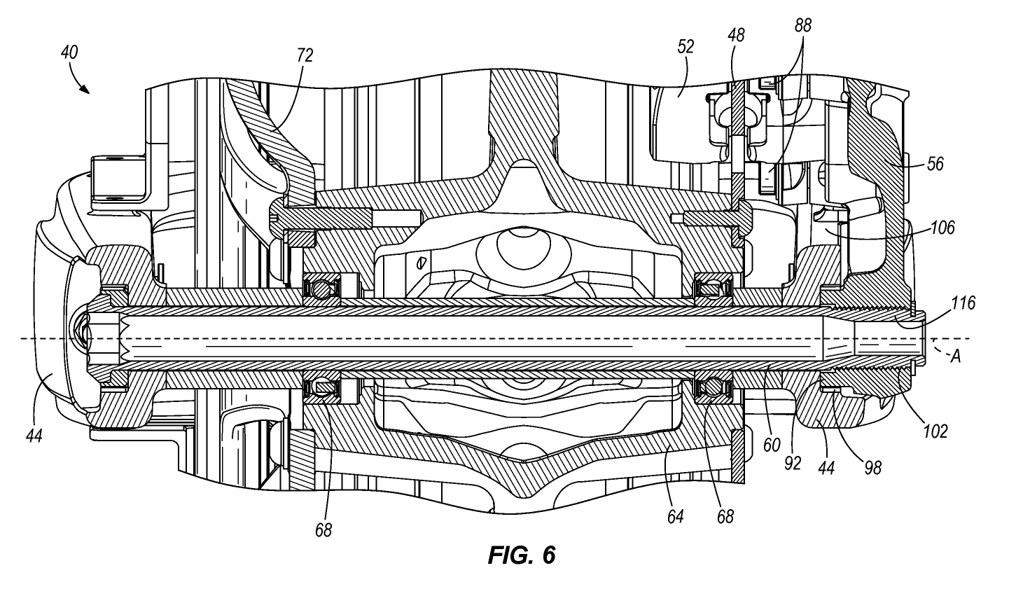

As shown in the cross-sectional view of FIG. 6, a stationary axle 60 extends through a hub 64 of the rear wheel 36, which is rotatably mounted on the axle 60 with a pair of bearings 68. A sprocket 72 is fixed to the rear wheel 36 at the hub 64. The sprocket 72 is selectively driven to rotate by power from the engine 28 and is coupled to the rear wheel 36 to drive the rear wheel 36 to move the motorcycle 20. Although illustrated as directly coupled to the rear wheel 36, the sprocket 72 is provided with an internal torque compensator in some embodiments and, as such, is mounted to the rear wheel 36 to allow a limited amount of relative rotation therebetween. The axle 60 defines an axis of rotation A (FIGS. 2 and 6) of the rear wheel assembly 40. The rear wheel 36, the brake disc 48, and the sprocket 72 all rotate relative to the swingarm 44 about the axis A. The axis A is movable with the rear wheel 36 and the swingarm 44 relative to the frame 24. In the illustrated construction, the swingarm 44 is pivotably mounted to the frame 24 such that the axis A can pivot along an arc about a swingarm pivot 76 (FIG. 2) when the rear wheel 36 encounters irregularities in the road surface.

As shown in FIGS. 2, 3, and 6, the sprocket 72 is disposed on a left lateral side of the rear wheel 36, and the brake disc 48 (along with the brake caliper 52) is disposed on a right lateral side of the rear wheel 36. Such an arrangement is shown by way of example, and it is conceived that the arrangement may be reversed to relocate the sprocket 72 on the right side of the rear wheel 36 and relocate the brake disc 48 to the left side of the rear wheel 36. Furthermore, the brake disc 48 and the sprocket 72 may be disposed on the same side of the rear wheel 36 (provided as separate components or integrated into a singular component).

In the illustrated construction, the rear brake caliper bracket 56 is disposed on a laterally outward side of the swingarm 44 (furthest from the rear wheel 36 as measured along the axis A). By positioning the rear brake caliper bracket 56 outside the swingarm 44, rather than between the rear wheel 36 and the swingarm 44, the swingarm 44 can be made more narrow, which reduces its weight. Furthermore, a narrower swingarm 44 makes the motorcycle 20 more compact overall and allows tighter packaging of other components (e.g., exhaust piping, muffler 78). The lateral compactness of the motorcycle 20 improves mass centralization and increases the allowable lean angle, enhancing handling performance and improving overall balance of the motorcycle 20.

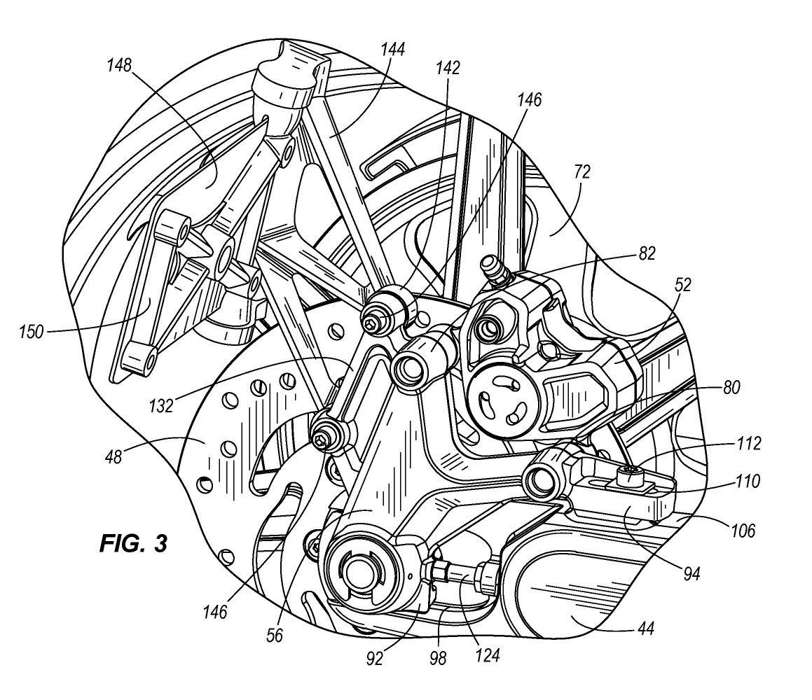

As shown in FIGS. 3-5, the rear brake caliper bracket 56 includes two caliper mounting portions 80, 82. Each of the caliper mounting portions 80, 82 includes a threaded aperture 86 configured to receive a threaded caliper mounting fastener 88. The apertures 86 are only open to one side of the rear brake caliper bracket 56—a laterally inward side 56A that faces the rear wheel 36. Thus, when the brake caliper 52 is coupled with the bracket 56, the fasteners 88 are hidden from view. Due to the close proximity of the rear brake caliper bracket 56 with the brake disc 48, the fasteners 88 may be required to be inserted into the apertures 86 prior to coupling the rear brake caliper bracket 56 to the swingarm 44.

With further reference to FIGS. 3-5, the rear brake caliper bracket 56 includes a first swingarm engaging portion 92 and a second swingarm engaging portion 94. The first swingarm engaging portion 92 is a generally horizontally protruding boss that extends into an aperture 98 formed in the swingarm 44. The first swingarm engaging portion 92 is adjustable within the aperture 98 of the swingarm 44. An axle engaging aperture 102 extends through the first swingarm engaging portion 92. The second swingarm engaging portion 94 extends farther forward than the first swingarm engaging portion 92 and engages an upper surface 106 of the swingarm 44. The second swingarm engaging portion 94 includes a slot 110 that is longitudinally oversized for adjustably receiving a fastener 112. The fastener 112 (e.g., a threaded screw) extends in a generally downward direction into engagement with the swingarm 44. The fastener 112 is positioned generally in the direction of the torque load path (of a torque applied to the bracket 56 when the caliper 52 squeezes the rotating brake disc 48). Therefore, the fastener 112 does not have particularly high loading requirements as most of the torque from the brake caliper 52 is transmitted directly through the second swingarm engaging portion 94 to the swingarm 44. The slot 110 enables the position of the rear caliper bracket 56 to be adjusted relative to the swingarm 44 when the fastener 112 is loosened.

The swingarm aperture 98 is oversized in a longitudinal direction (generally parallel to the elongated direction of the slot 110) to allow for adjusting the position of the rear brake caliper bracket 56 relative to the swingarm 44. Because the axle 60 is received within the aperture 102 of the rear brake caliper bracket 56, the adjustment of the bracket 56 relative to the swingarm 44 also adjusts the position of the axis A, and the entire rear wheel assembly 40, relative to the swingarm 44.

In the illustrated construction, the axle 60 is provided with an externally threaded end portion 116 that is received by the aperture 102, which includes complementary internal threads. In this way, the rear brake caliper bracket 56 is operable to secure and retain the axle 60 relative to the swingarm 44. The rear brake caliper bracket 56 can be held stationary while the axle 60 is tightened to apply a desired amount of axial preload to the bearings 68. The threaded aperture 102 of the rear brake caliper bracket 56 obviates the need for a conventional axle nut to be separately provided and tightened onto the axle 60. It is conceived that the rear brake caliper bracket 56 may be provided with alternate structure to engage and retain the axle 60 relative to the swingarm 44 depending upon the particular axle configuration.

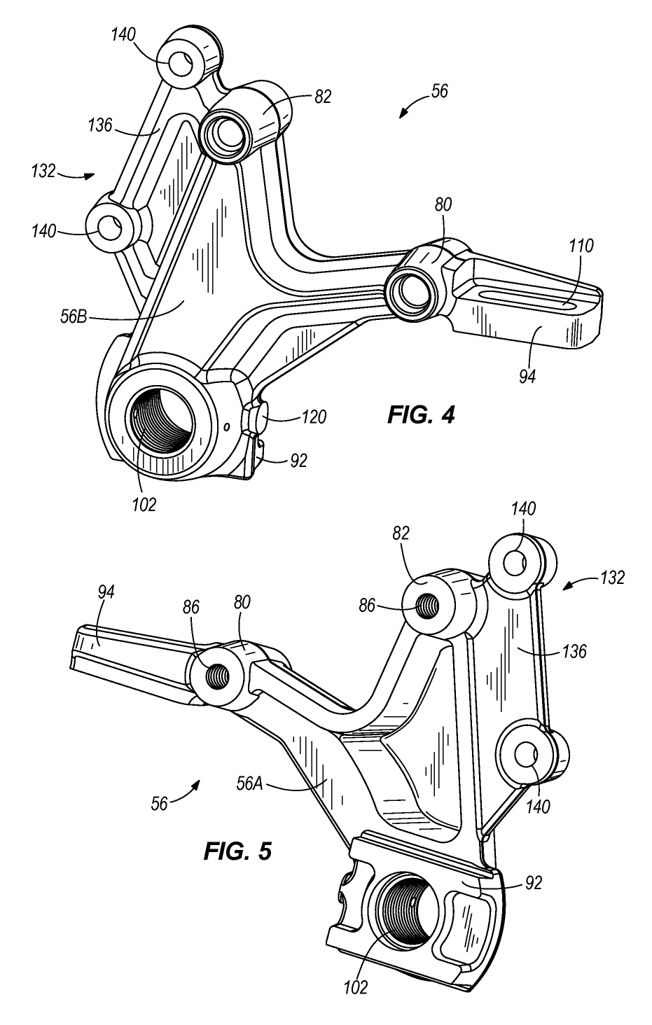

In the area of the first swingarm engaging portion 92 that extends into the elongated aperture 98 in the swingarm 44, the rear brake caliper bracket 56 includes a substantially flat load bearing surface 120 (FIG. 4). An axle adjusting member 124 (FIG. 3) is threaded into the swingarm 44 adjacent the aperture 98 and extends generally into the aperture 98 and into contact with the surface 120 on the rear brake caliper bracket 56. Rotation of the adjusting member 124 relative to the swingarm 44 extends/retracts the adjusting member 124 and adjusts the position of the rear axle 60, and with it the sprocket 72 and the rear wheel 36, relative to the swingarm 44. A similar adjustment mechanism may be provided on the opposite side of the swingarm 44 (adjacent the sprocket 72) so that drive member (e.g., chain, belt) tension and/or rear wheel alignment may be adjusted.

As shown in FIGS. 2-5, the rear brake caliper bracket 56 includes a license plate mounting portion 132. In the illustrated construction, the license plate mounting portion 132 is positioned at a rearward side of the rear brake caliper bracket 56. The license plate mounting portion 132 includes a flange 136 with a pair of apertures 140. The apertures 140 are aligned with mounting portions 142 (one shown in FIG. 3) in a license plate mounting bracket 144 so that a pair of fasteners 146 extend through the apertures 140 and into engagement with the mounting portions 142 to couple the license plate mounting bracket 144 to the rear brake caliper bracket 56. The mounting portions 142 may include threaded apertures.

The license plate mounting portion 132 is configured to display a license plate 148 alongside the rear wheel 36. The license plate mounting bracket 144 includes a license plate holder 150 spaced from the mounting portions so that the license plate 148 is spaced from the rear brake caliper bracket 56. The holder 150 may be adjustable and/or foldable relative to the license plate mounting bracket 144 and the rear brake caliper bracket 56. The license plate mounting portion 132 may alternately mount a different style of license plate mounting bracket from that shown, or may be used to directly support the license plate 148 without a bracket. The fasteners 146 extend through the apertures 140 from a laterally outward side 56B of the rear caliper bracket 56 (FIG. 3). Thus, the fasteners 146 are accessible such that the license plate mounting bracket 144 may be removed or replaced without removing the rear brake caliper bracket 56 from the swingarm 44.

Thus, the invention provides, among other things, a multi-functional rear brake caliper bracket 56 that is mounted to the swingarm 44. Various features and advantages of the invention are set forth in the following claims.

What is claimed is:

1. A motorcycle comprising:
a frame;
a swingarm coupled to the frame;
a rear wheel coupled to the swingarm so that the rear wheel is rotatable relative to the swingarm and movable with the swingarm relative to the frame;
a brake disc coupled to the rear wheel to rotate with the rear wheel;
a rear brake caliper bracket coupled to the swingarm, the rear brake caliper bracket including a caliper mounting portion and a license plate mounting portion; and
a brake caliper coupled to the caliper mounting portion of the rear brake caliper bracket and configured to selectively squeeze the brake disc to decelerate the rear wheel.

2. The motorcycle of claim 1, wherein the license plate mounting portion is configured to display a license plate alongside the rear wheel.

3. The motorcycle of claim 1, further comprising a license plate bracket coupled to the license plate mounting portion of the rear brake caliper bracket and configured to display a license plate at a location spaced from the rear brake caliper bracket.

4. The motorcycle of claim 1, wherein the caliper mounting portion includes an aperture, the motorcycle further comprising a fastener extending through the brake caliper and fixed within the aperture to secure the brake caliper to the caliper mounting portion of the rear brake caliper bracket.

5. The motorcycle of claim 4, wherein the rear brake caliper bracket has an interior side generally facing the rear wheel and an exterior side generally facing away from the rear wheel, wherein the fastener is insertable into the aperture from the interior side.

6. The motorcycle of claim 1, wherein the rear brake caliper bracket includes a swingarm engaging portion received within an aperture formed in the swingarm.

7. The motorcycle of claim 6, further comprising an axle defining an axis of rotation of the rear wheel, wherein the axle is received by an aperture through the swingarm engaging portion of the rear brake caliper bracket.

8. A motorcycle comprising:
a frame;
a swingarm coupled to the frame;
a rear wheel coupled to the swingarm so that the rear wheel is rotatable relative to the swingarm and movable with the swingarm relative to the frame;
an axle extending through the center of the rear wheel, the axle defining an axis of rotation of the rear wheel with respect to the swingarm;
a brake disc coupled to the rear wheel to rotate with the rear wheel;
a rear brake caliper bracket coupled to the swingarm, the rear brake caliper bracket including an axle engaging portion engaged with the axle, and a caliper mounting portion; and
a brake caliper coupled to the caliper mounting portion of the rear brake caliper bracket and configured to selectively squeeze the brake disc to decelerate the rear wheel,
wherein the axle engaging portion secures and retains the axle relative to the swingarm in a desired position along the axis of rotation.

9. The motorcycle of claim 8, wherein the caliper mounting portion includes an aperture, the motorcycle further comprising a fastener extending through the brake caliper and fixed within the aperture to secure the brake caliper to the caliper mounting portion of the rear brake caliper bracket.

10. The motorcycle of claim 9, wherein the rear brake caliper bracket has an interior side generally facing the rear wheel and an exterior side generally facing away from the rear wheel, wherein the fastener is insertable into the aperture from the interior side.

11. The motorcycle of claim 8, wherein the rear brake caliper bracket includes a license plate mounting portion.

12. The motorcycle of claim 11, wherein the license plate mounting portion is configured to display a license plate alongside the rear wheel.

13. The motorcycle of claim 11, further comprising a license plate bracket coupled to the license plate mounting portion of the rear brake caliper bracket and configured to display a license plate at a location spaced from the rear brake caliper bracket.

14. The motorcycle of claim 8, wherein the axle engaging portion of the rear brake caliper bracket is in threaded engagement with an end of the axle.

15. The motorcycle of claim 14, wherein the axle engaging portion is formed with a threaded aperture, and the axle is formed with male threads that engage the threaded aperture.

16. The motorcycle of claim 8, wherein the axle engaging portion of the rear brake caliper bracket is adjustably received within an aperture formed in the swingarm.

17. A motorcycle comprising:
a frame;
a swingarm coupled to the frame;
a rear wheel coupled to the swingarm so that the rear wheel is rotatable relative to the swingarm and movable with the swingarm relative to the frame;
an axle extending through the center of the rear wheel, the axle defining an axis of rotation of the rear wheel with respect to the swingarm;
a brake disc coupled to the rear wheel to rotate with the rear wheel;
a rear brake caliper bracket coupled to the swingarm and disposed at a laterally outward side of the swingarm, the rear brake caliper bracket including a caliper mounting portion, first and second swingarm engaging portions, and an axle engaging portion;
an axle adjusting member engaged with the rear brake caliper bracket and operable to adjust the position of the axle relative to the swingarm; and
a brake caliper coupled to the caliper mounting portion of the rear brake caliper bracket and configured to selectively squeeze the brake disc to decelerate the rear wheel.

18. The motorcycle of claim 17, wherein the first swingarm engaging portion is adjustably disposed within an aperture formed in the swingarm.

19. The motorcycle of claim 18, wherein the second swingarm engaging portion engages an upper surface of the swingarm and is fastened thereto with a fastener extending in a direction generally along the torque load path between the brake disc and the brake caliper.

20. The motorcycle of claim 17, wherein the axle engaging portion does not engage the axle at any point laterally between the swingarm and the rear wheel.
